(19) United States
(12) Patent Application Publication
(10) Pub. No.: US 2009/0248485 A1
(43) Pub. Date: Oct. 1, 2009

(54) Communications Propensity Index

(76) Inventors: George Minow, Boise, ID (US); Michael Gale, Austin, TX (US)

Correspondence Address: Zarian Midgley & Johnson PLLC, University Plaza, 960 Broadway Ave., Suite 250, Boise, ID, 83706, US

(21) Appl. No.: 12/058,268

(22) Filed: Mar. 28, 2008

(51) Int. Cl. G06Q 30/00

(52) U.S. Cl. 705/10

(57) ABSTRACT

A method of analyzing the effectiveness of marketing activities involves taking a series of surveys that incorporate such factors as the purchase process cycle stages, organization size, respondent job responsibilities, the products offered, and brands involved. The data from the marketing surveys is compiled. A user enters a specific query directed at the data, and the method of the invention is used to present graph of the data results to the user, the graph having a vertical and two horizontal axes. Marketing vehicles are listed on the vertical axis of the graph. On one horizontal axis, a percentage impact awareness score is provided for each marketing vehicle for the selected query, as well as an overall average percentage impact awareness score for all of the marketing vehicles. The other, opposing horizontal axis displays a brand propensity index for each marketing vehicle, as well as an overall average brand propensity index. The user may compare the percentage impact awareness of each marketing vehicle to the brand propensity index for each marketing vehicle to determine the effectiveness of each marketing vehicle for a brand in question as opposed to the effectiveness of each marketing vehicle across all brands for the selected market filtration.

### BACKGROUND

The present application relates to a method for providing a statistical analysis of the effectiveness of company marketing activities, and in particular marketing activities as they may be directed to the awareness, consideration, and purchase of goods and services as represented by company brands. The method thus provides feedback on development and use of comprehensive marketing programs.

Typical purchasing decisions arise from awareness of a good or service being offered under a particular brand, consideration of the various different brands under which the good or service is offered, and ultimately purchasing the good or service. Vendors of goods and services seek to impress upon potential customers the value of their product, as represented by the brand under which the product is offered. Vendors typically do this using various different marketing vehicles, such as direct mail, catalogs, e-mail, web sites, seminars, content inserts, and other types of advertising. Purchasing decisions thus involve a purchasing cycle of awareness, consideration, and purchase.

During the purchasing cycle, customers develop brand preferences, which include both past preferences and future preferences. Unfortunately, companies have had difficulty measuring the effectiveness of various marketing vehicles when communicating with potential customers. In addition, companies need to understand their relationship with potential customers, including such things as whether a given customer granted permission to communicate.

Unfortunately, companies have not been able to measure the effectiveness of various marketing vehicles overall, or even at a given step in the purchasing cycle. Companies have not be able develop the marketing data necessary to analyze the effectiveness of a given marketing vehicle in terms of awareness, consideration or purchase. Even if such information was available, companies have not had an easily understood way of presenting and viewing such evidence.

Companies have not generally known whether, for example, direct mail to a potential customers is more or less effective than other marketing vehicles for awareness, consideration or purchase decisions. No method has been developed to take preferences by brand and marketing vehicle and compare such data to evaluate the effectiveness of individual marketing vehicles. As a result, companies have often had only anecdotal evidence of what sorts of marketing vehicles are useful in the relevant industry for each part of the purchasing cycle. Thus, a method of measuring the effectiveness of individual marketing vehicles as used in specific target industry areas at each step of the purchasing cycle would be very useful.

### SUMMARY

A method is provided for companies to measure the effectiveness of marketing vehicles for awareness, consideration and purchase with regard to specific technologies, in a specific target industry, for specific types of customers, and by brand. The analytics involved with the method provide what may be called a Communications Propensity Index or “CPI” as a measure of marketing vehicle effectiveness. The CPI in turn is based on a Percentage Impact Awareness (“PIA”) score and a Brand Propensity Index (“BPI”) score, each of which is a measure of effectiveness for individual marketing vehicles by brand with respect to awareness, consideration, or purchase in the specified target industry.

The CPI is designed to show how effective various sales and marketing vehicles are in creating awareness, consideration or purchase with potential customers. The CPI compares receptiveness of potential customers to a specific company communicating with them versus communications from other companies. By considering data regarding past and future preferences relating to a brand of one company compared to a wide selection of competing brands in the industry, metrics are devised that show whether a marketing vehicle is effective with potential customers and how effective a particular company has been using that marketing vehicle.

The data is organized in a way that shows that a particular marketing vehicle may be very effective, but that a company is not capitalizing on that effectiveness, thereby suggesting the company increase its investment in that marketing vehicle (that is, the company is under-investing in a specific marketing vehicle). Conversely, the CPI can show where a marketing vehicle is not effective, and that the company is overusing that vehicle (that is, the company is over-investing in a specific marketing vehicle). In essence, the CPI indicates in what marketing vehicles to invest, and not to invest, for awareness, consideration, and purchase, and also compares effectiveness against competitors.

In one embodiment, a series of marketing surveys are conducted that are designed to elicit responses categorized by marketing stage and brand awareness for a variety of marketing vehicles (such as direct mail, advertising, Internet web pages, etc.). The marketing surveys are directed to respondents having a variety of job responsibilities (such as C-suite level people, technology level people and purchasing agent level people), employed by companies and other organizations of various sizes in a specific technology or industry segment. The marketing surveys use a variety of open-ended questions to obtain responses directed to brands of which the respondents are aware (awareness), would consider (consideration), and would purchase (thus, to the complete purchase cycle) in selecting goods or services.

Once completed, the data from the marketing surveys is accumulated and an overall average percentage impact awareness (“PIA”) score is calculated for all of the marketing vehicles and for each of the issues of awareness, consideration and purchase. The calculated average PIA is essentially a measure of the average importance of the marketing vehicles to the product cycle stage. Thus, the average PIA is a baseline against which the various marketing vehicles can be compared to identify the generally more effective and generally less effective marketing vehicles in the specific industry, by job responsibility of the respondents, for the steps of the purchase cycle.

A PIA for each marketing vehicle is also calculated based on the number of responses that cite each marketing vehicle. The PIA for each marketing vehicle is plotted on a graph with each marketing vehicle listed along a vertical axis and the PIA for each such marketing vehicle plotted on the horizontal axis. The calculated average PIA for the product cycle step is also plotted as a vertical line against the horizontal axis.

An overall average Brand Propensity Index (“BPI”) is calculated by taking the percentage of respondents who mentioned any brand in response to the marketing survey, adding all of the non-zero percentages, and dividing the resulting sum by the total number of brands mentioned. A BPI for a chosen specific brand for each marketing vehicle is derived by dividing the number of marketing survey respondents who mentioned the chosen brand by the total number of marketing survey respondents.

The BPI for the chosen brand for each marketing vehicle is then plotted against the vertical axis of the graph (the axis having the marketing vehicles listed). This plot may be understood as forming a third axis on the graph, which third axis is co-linear with, but on the side opposite to, the axis for the PIA plotting. The overall average BPI is also plotted along that third axis, as a vertical line marked at the average BPI value.

With these values plotted on the three-axis graph, the BPI for a single brand may be compared to the vertical line showing the overall BPI. Likewise, the PIA for each marketing vehicle may be compared to the overall average PIA. These opposing plots show what marketing vehicles are effective (compared to the vertical line average PIA) and how a particular brand measures up to the average of brands in the industry (using the vertical line showing average BPI). Furthermore, by comparing the plotted values on both sides of the graph, a company can see what types of marketing vehicles are effective for the chosen purchase cycle segment, where the company's own marketing efforts are effective, and what sort of correlation there is between the two. Thus, the systems and methods described herein enable companies to quantitatively assess and re-evaluate their marketing strategies.

### BRIEF DESCRIPTION OF THE DRAWINGS

Other features and advantages of the present invention will be apparent from reference to the following Detailed Description taken in conjunction with the accompanying Drawings, in which:

FIG. 1 depicts a three axis graph generated in accordance with one embodiment of the present application;

FIG. 2 is a flowchart of the method steps of the present application;

FIG. 3 depicts an initial computer interface web page for generating a three axis graph for a selected market filtration;

FIG. 4 depicts a sample Communications Propensity Index introductory web page used in generating a three axis graph for a selected market filtration;

FIG. 5 depicts a sample technology selection web page used in generating a three axis graph for a selected market filtration;

FIG. 6 depicts an organization size selection web page used in generating a three axis graph for a selected market filtration;

FIG. 7 depicts a segment selection web page used in generating a three axis graph for a selected market filtration;

FIG. 8 depicts a sample purchasing cycle stage selection web page used in generating a three axis graph for a selected market filtration;

FIG. 9 depicts a sample brand selection web page used in generating a three axis graph for a selected market filtration; and

FIG. 10 depicts a sample completed CPI chart web page for the selected market filtration.

### DETAILED DESCRIPTION

A method is provided to assist companies in analyzing the effectiveness of marketing activities with respect to a purchase process cycle including issues of awareness, consideration, or purchase. In one embodiment, the overall process involves conducting a series of surveys with respect to various brands, directed at specific technologies and to respondents of different job descriptions. The survey results are compiled and presented in a three-axis graph. A user may review the graph and develop a sense of the value of various marketing vehicles for different brands, in front of people with different job responsibilities, and based on specific technologies or other business areas.

The process begins with a series of wide-ranging surveys of specific technologies, business products, or services available for purchase. Each survey begins by identifying a specific technology or other business area to be surveyed. Organizations offering products or services in that technology are next identified and classified by size.

A specific segment of the identified organizations is preferably selected. This selection may be determined by various factors, but in one embodiment the segment is determined by the job title or position of the respondent. For instance, the job responsibilities of the selected segment may be respondents from the C-suite (CEO, COO, CIO, CFO, etc.) of a company, or from purchasing agents, or from marketing executives, or other such segments. Alternatively, the segment may be based on business structures, such as foreign subsidiary or operating unit. The chosen segment will depend on the particular information to be collected. In one embodiment, respondents are selected from more than one segment, providing additional information for analysis.

Next, at least one portion of the purchasing cycle is selected. The purchasing cycle may be understood as involving awareness of a product (good or service), consideration of the various different brands under which the product is offered, and ultimately purchasing the product. Typically, the marginal costs of obtaining responses relating to all three portions of the purchasing cycle are so slight that all three are surveyed in each survey. Also, brands and companies are identified for use in the survey.

Once the technology or business products are chosen, the marketing surveys designed and prepared, and the business segments and purchasing cycle selected, a plurality of the marketing surveys are directed at the identified respondents. The marketing surveys typically include a number of open-ended questions designed to elicit responses related to the respondents' past and future preferences for a specific brand. In this regard, the design of the marketing surveys is well within the ordinary skill of those in the marketing survey art.

Once taken, the data from the marketing surveys is collected and stored in a suitable database, as is known in the art. Because of the design of the surveys, the data will contain information that relates to different business segments and technology, the size of the business entities from which the survey data was compiled, the job responsibility characteristics of the respondents, and the brand or company awareness regarding each of the selected marketing vehicles with respect to the purchasing cycle steps of awareness, consideration and purchase. Thus, there is significant data collected, and the next step is to present the data in a way that is easily digested and useful for future marketing decisions.

To that end, an overall average percentage impact awareness (“PIA”) score is calculated for each of the marketing vehicles and for each step in the purchase process cycle. This calculation is enabled because the marketing surveys preferably asked each respondent to specify a set number of the marketing vehicles that have the most effect on the respondent, during each step in the purchasing cycle. In other words, each respondent may be asked a question such as “When you think of firewall or gateway goods or services which sales or marketing vehicles create awareness or familiarity?”, When you think of laptops which sales or marketing vehicles create consideration or preference?”, When you think of business applications which sales or marketing vehicles create purchase?”. The overall average PIA is calculated by dividing the number of marketing vehicles permitted in each of the specified responses by the total number of marketing vehicles given in the survey. Furthermore, a PIA for each of the marketing vehicles is also revealed by the marketing survey data, as the percentage of respondents that list the marketing vehicle as being influential in brand identification with regard to each step of the purchasing cycle.

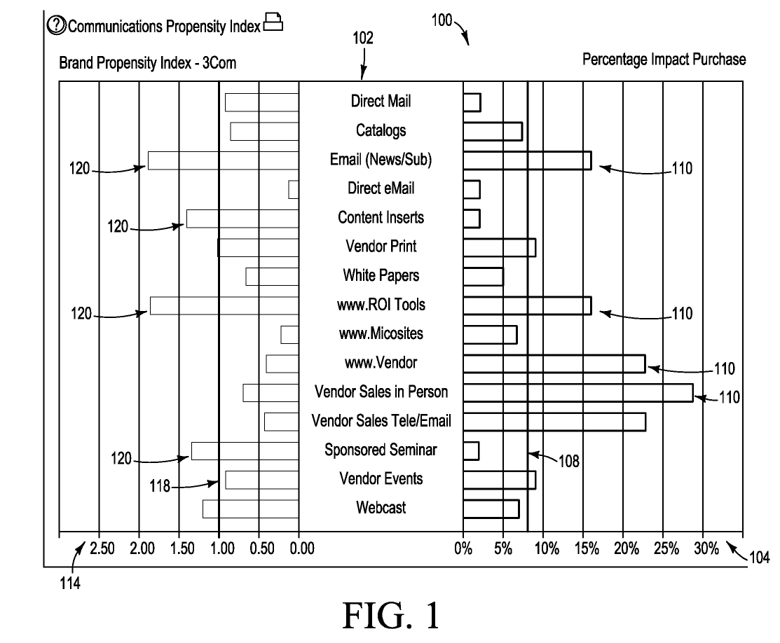

As depicted in FIG. 1, the PIA for each of the marketing surveys is charted on a communications propensity index (“CPI”) graph 100. The middle column 102 of the CPI graph 100 lists the various marketing vehicles mentioned by the respondents to the marketing surveys. The PIA for each of the marketing vehicles is charted on the right side 104 of the CPI graph. For example, in the embodiment shown in FIG. 1, the marketing vehicles include a survey-determined PIA for direct mail, catalogs, e-mail (newsletters/subscriptions), direct e-mail, content inserts, vendor print, white papers, www.ROI tools, www.microsites, www.vendor.com, vendor sales people, telesales people, sponsored seminars, vendor events, and webcasts. Although not depicted in FIG. 1, but as explained below, in the illustrated embodiment, the PIA scores are based not only on the marketing vehicles, but are also filtered for technology, purchasing cycle step, and business segment, so that each graph depicts a market filtration for those factors.

In addition to the PIA for each marketing vehicle, the overall average PIA is shown as a vertical line 108 (which is typically depicted in a color, such as red) in the PIA chart 104. The PIA scores shown for each of the marketing vehicles on the right side chart of FIG. 1 indicate how important various marketing vehicles are in influencing customers in their awareness, consideration or purchase decisions of products. The overall average PIA vertical line 108 in this example is approximately 8%, so black bars 110 that go past the vertical line 108 indicate that those particular marketing vehicles more effectively influence customers than other marketing vehicles. For example, in the sample graph shown in FIG. 1, Vender Sales in Person has a high PIA score, whereas the Direct Mail PIA score is low. As a result, a user can quickly conclude that to achieve high brand recognition in this market filtration, the user should focus on Vender Sales in Person over Direct Mail.

In addition to the PIA, an overall brand propensity index (“BPI”) is also calculated from the data generated by the marketing surveys. The overall BPI is calculated by taking the percentage of respondents who mentioned an individual brand in response to the appropriate marketing survey question, adding all the percentages calculated, and dividing the resulting sum by the total number of discrete brands mentioned. Furthermore, a BPI for a single brand for each marketing vehicle is calculated by having each marketing survey respondent identify the brands for which they have preference (both past and future preference), and for each of the brands mentioned, dividing the number of respondents who mention a brand by the total number of marketing survey respondents.

In one embodiment, the BPI scores for each of the marketing vehicles are charted on the CPI graph 100 opposite the PIA chart 104. As depicted in FIG. 1, the BPI for each of the marketing vehicles is charted on the left side 114 of the CPI graph 100. Similar to the PIA scores, the BPI scores are charted with respect to the same marketing vehicles, as depicted in FIG. 1. These BPI scores are based not only on the marketing vehicles as well as the technology, purchasing cycle, and other parts of the selected marketing filtration, but are also particular for a given brand. That is, review of the PIA scores shows the effectiveness of marketing vehicles for all brands, whereas the BPI scores show the effectiveness of marketing vehicles for a specific brand.

In addition to the BPI for each marketing vehicle, the overall average BPI is shown as a vertical line 118 (typically depicted in a color) in the BPI side 114 of the CPI graph 100. The BPI scores shown for each of the marketing vehicles on the left side of the CPI chart of FIG. 1 indicate how important various marketing vehicles are in influencing customers in their awareness, consideration or purchase decisions of products in the selected marketing filtration. The overall average BPI vertical line 118 in the chart shown in FIG. 1 is 1.0, so BPI bars 120 (which may be black, but may also be in a different color) that go past the overall average BPI vertical line 118 indicate that those particular marketing vehicles more effectively influence customers with respect to the chosen brand than average, in the selected marketing filtration. For example, in the sample graph shown in FIG. 1, eMail and www.ROI Tools have high BPI scores, meaning that the brand in question is well known for use of those marketing vehicles in the marketing filtration shown in the graph, whereas Direct eMail and www.microsites show a low BPI score.

With the BPI scores and PIA scores for the user-selected market filtration charted on the CPI chart 100, a user may compare (1) the BPI for a single brand to the overall BPI, (2) the PIA for various marketing vehicles to the overall PIA, and (3) the BPI for the brand to the PIA for that brand for each marketing vehicle. With these comparisons, a user may quickly determine what marketing vehicles are most effective, whether the brand is being successful at using the specific vehicle in creating awareness, consideration or purchase, and how well that brand creates preference compared to other brands in that market filtration.

For instance, to generate the chart shown in FIG. 1, a market filtration for simulated survey results was selected based on technology (IP Telephony), company size (100-999 employees), business segment (TDM), marketing stage (Purchase) and brand (3Com®). In this so-designated market filtration, the PIA scores show that the best marketing vehicles to use are e-mail, www.ROI tools, www.vendor.com, vendor sales people, and telesales people. Thus, to most effectively command brand attention in that market filtration, those are the marketing vehicles to use. However, as the BPI scores show, 3Com® is most effective in e-mail, content inserts, www.ROI tools, sponsored seminars, and webcasts. Thus, a user may see that 3Com® might want to move marketing efforts from content inserts, sponsored seminars, and webcasts and into the three most effective vehicles, www.vendor.com, vendor sales people, and telesales, while perhaps leaving some emphasis in existing e-mail and www.ROI tools efforts. The result is that a user may quickly determine where to focus its marketing activities to increase the value of a given brand, and also where to reduce focus.

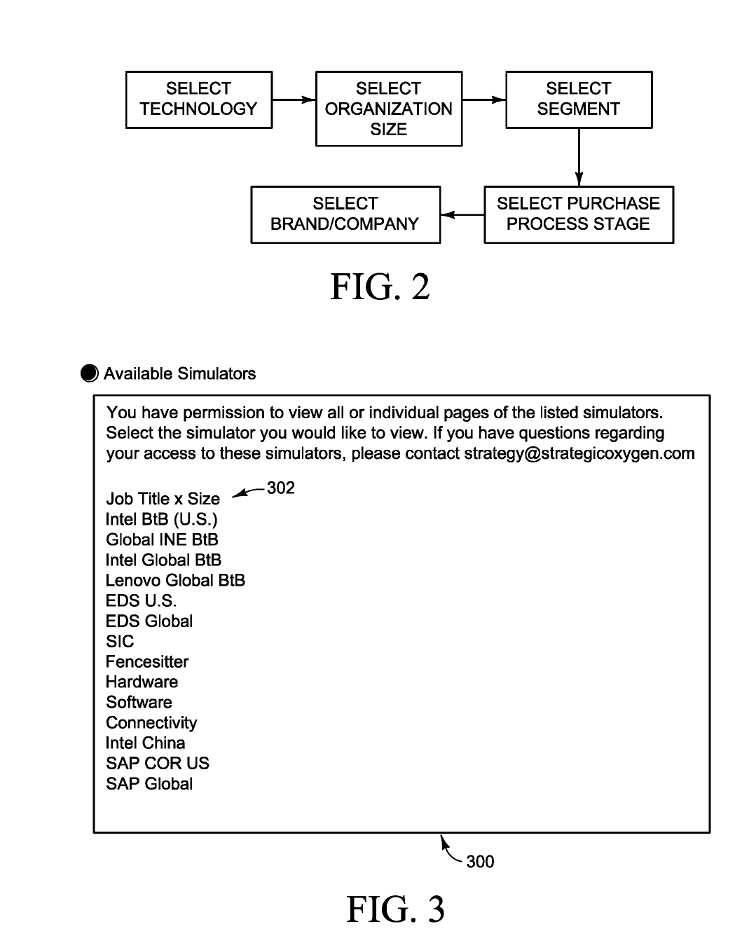

The method of the present application may be further understood by considering a hypothetical example of one embodiment, as it may be used. As an overview, the user determines the desired market filtration. FIG. 2 provides a flow chart of the process of selecting a market filtration.

Typically, the disclosed system will be used through a web browser or other computer interface. Thus, a user opens a browser, in some embodiments after logging in to a secure site, and navigates to reach an introductory web page. An example introductory page 300 is depicted in FIG. 3.

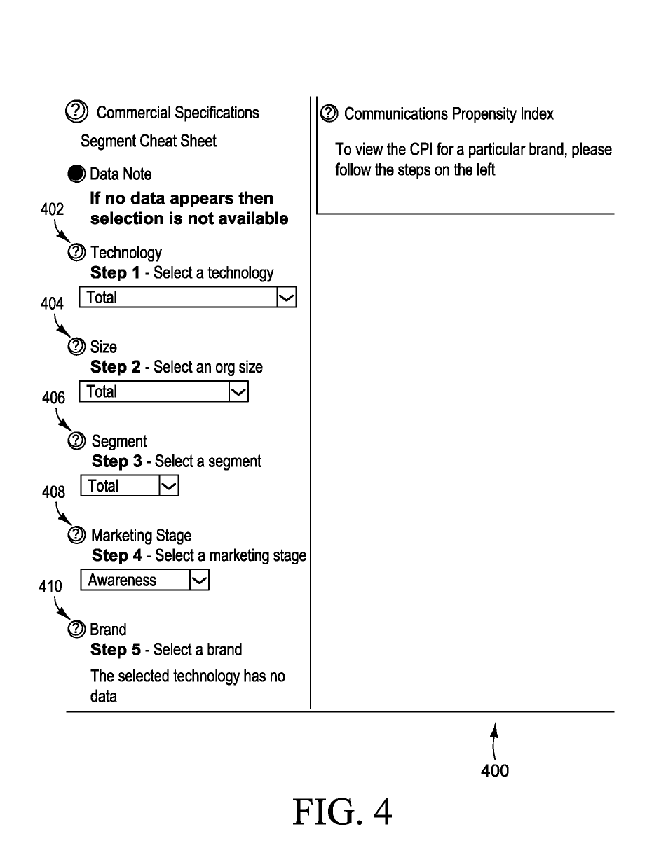

As shown in FIG. 3, the introductory web page 300 permits a user to sort the data by different categories. In this example, the user chooses “Job Title x Size” meaning that the user will generate a graph based on the job title and the company size of respondents. The user clicks on the hot link 302, and obtains a CPI introductory screen 400, an example of which is depicted in FIG. 4.

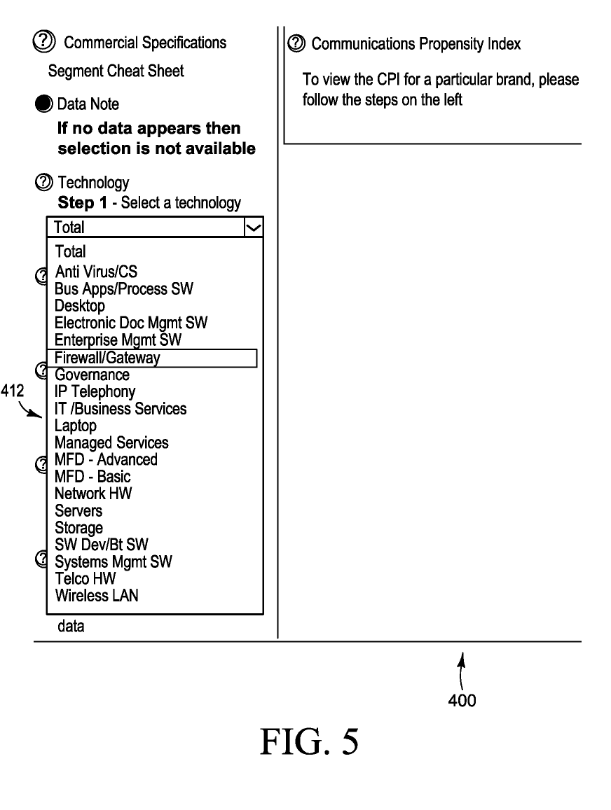

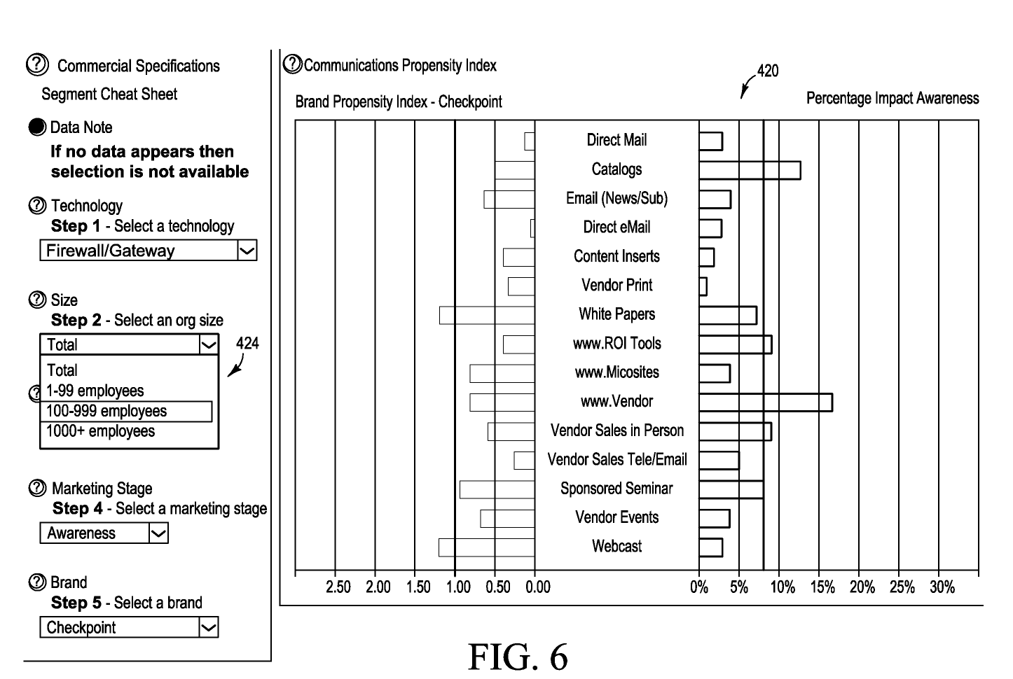

The CPI introductory screen 400 has a series of selections for further data refinement to obtain the desired market filtration. As depicted in FIG. 4, the user has choices of technology 402, organization size 404, segment 406, marketing stage 408 (that is, purchasing cycle stage), and brand 410. As depicted in FIG. 5, from a technology drop-down menu 412, the user may select “Firewall/Gateway” as the technology for which data is desired. Upon selection of a technology, an initial graph 420 may be generated, one that provides an overall view across all organization sizes, segments, marketing stages and brands, or one that has one or more of those factors incorporated as a result of those factors being default selections at the beginning of the market filtration process. As depicted in FIG. 6, the user may then select an organization size, in this example 100-999 employees, from an organization size drop-down menu 424.

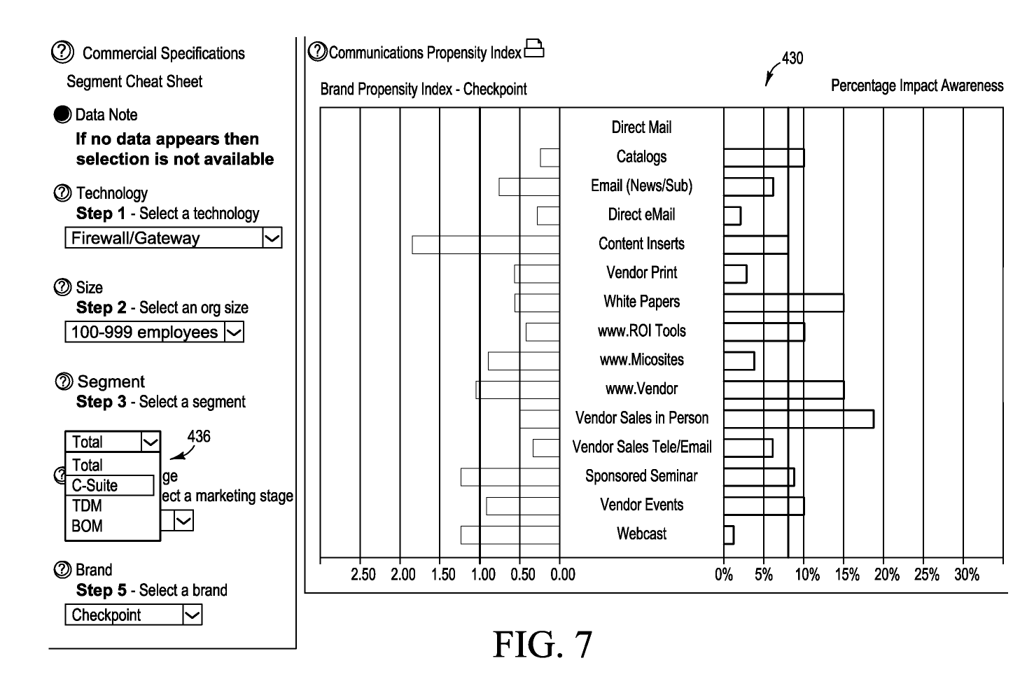

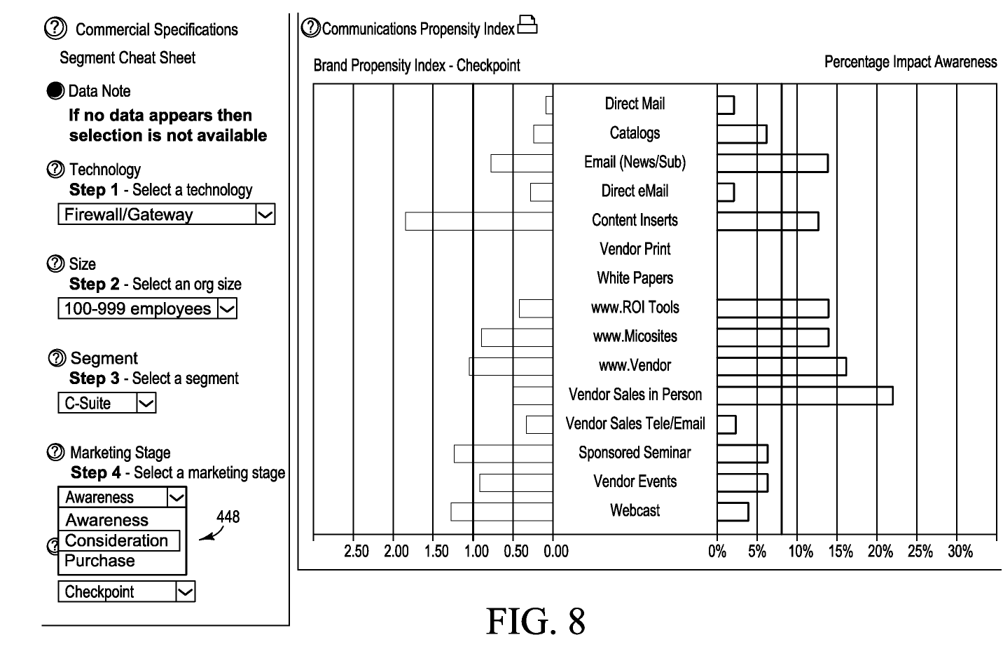

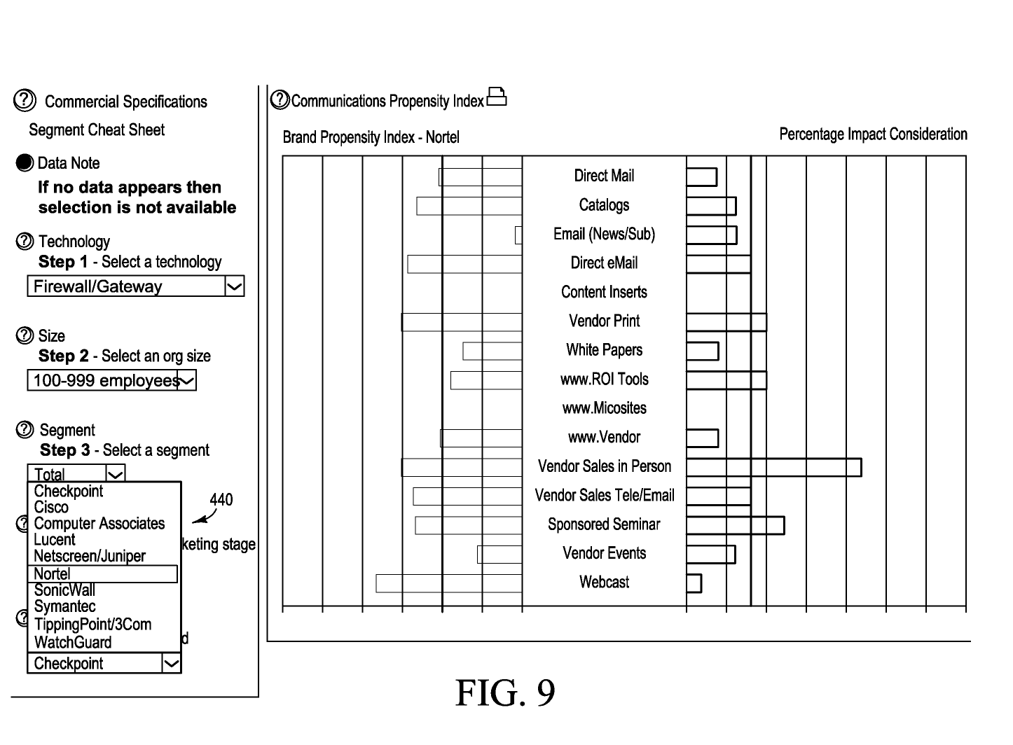

Upon selection of the organization size, another graph 430 may be generated, one that provides an overall view across all segments, marketing stages and brands. Such a chart is depicted in FIG. 7, as is the user's hypothetical selection of “C-Suite” as the business segment from a business segment drop-down menu 436. The user then may select the desired portion of the purchasing cycle (or marketing stage) from a marketing stage drop-down menu 448, as depicted in FIG. 8. Finally, as depicted in FIG. 9, the user selects a brand from a brand menu 440.

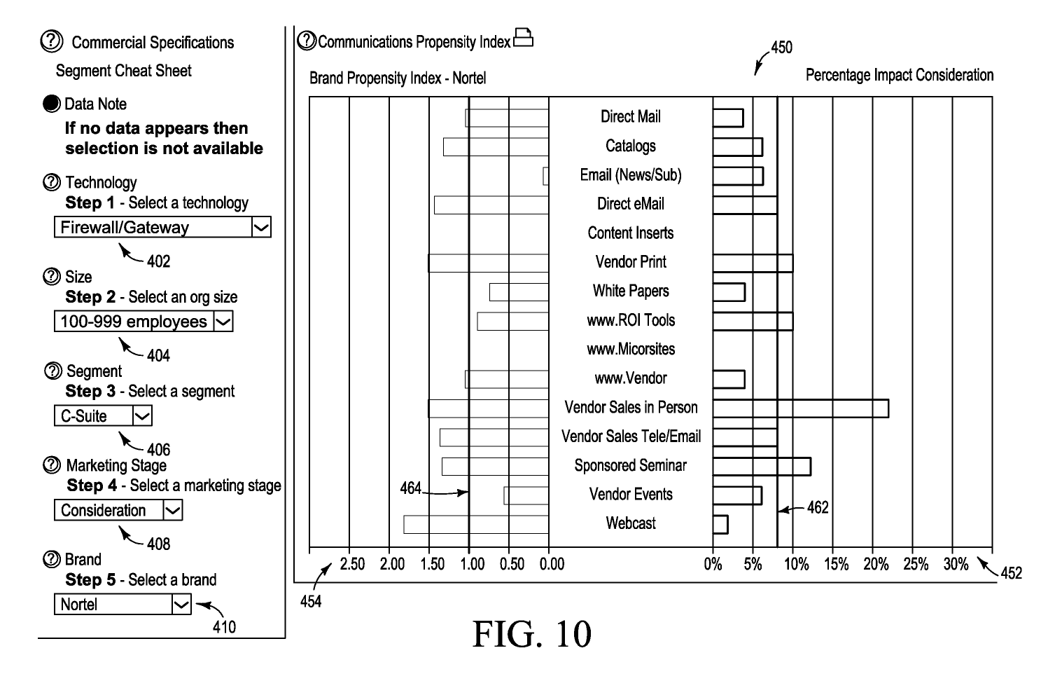

The result is a CPI graph 450 with the marketing survey data relating to each of the factors incorporated into the graph. As depicted in FIG. 10, the hypothetical graph 450 is for the market filtration of Firewall/Gateway, from C-Suite people employed by companies having 100-999 employees, relating to consideration for purchase of products bearing the Nortel® brand. According to this embodiment, the PIA scores are on the right side 452 and the BPI scores on the left side 454 of the graph 450 depicted if FIG. 10.

As can be seen from the hypothetical graph depicted in FIG. 10, for C-Suite people in the designated technology, organization size, and purchasing cycle stage, Vendor Sales in Person has a high PIA score, and Direct eMail, Vendor Print, www.ROI Tools, Vendor Sales Tele/Email, and Sponsored Seminar are also at or above the overall average PIA score. Thus, these marketing vehicles provide the best results in the selected market filtration. A user may thus quickly refer to a graph 450 such as the hypothetical one depicted in FIG. 10 to see where to focus the user's efforts for optimal effect in that market filtration.

As can further be seen from the hypothetical graph 450 depicted in FIG. 10, the Nortel® brand has a BPI score at or above the overall average BPI score for the Direct Mail, Catalogs, Direct eMail, Vendor Print, www.Vendor, Vendor Sales in Person, Vendor Sales Tele/Email, Sponsored Seminar, and Webcast marketing vehicles. A user may refer to a graph 450 such as the hypothetical one depicted in FIG. 10 to see, from the overlap of the at or above average PIA 462 and BPI 464 scores, that Nortel does well in Direct Mail, Catalogs, Direct eMail, Vendor Print, www.Vendor, Vendor Sales in Person, Vendor Sales Tele/Email, Sponsored Seminar, and Webcast for this target audience. With respect to Direct eMail, Vendor Print, www.Vendor, Vendor Sales in Person, Vendor Sales Tele/Email, Sponsored Seminar, and Webcast, these same marketing vehicles are effective when directed at the target audience, and thus Nortel may want to continue its actions if not increase its investment in those marketing vehicles.

However, as depicted in the hypothetical graph 450 of FIG. 10, while Nortel® does very well in Webcast, Direct Mail, and Catalogs, but those are not important factors in reaching the selected market filtration (C-Suite, 100-999 employees, Firewall/Gateway, Consideration, see the selections made as depicted on the left side of FIG. 10). Conversely, www.ROI Tools is an important factor for the selected market filtration, but Nortel® has not been effective at even an average level for that marketing vehicle. Thus, a Nortel® marketing person may want to re-allocate resources away from Webcast and into www.RIO Tools to increase its effectiveness at reaching the target audience. Indeed, based on this hypothetical, Nortel® may wish to increase investment in Vendor Sales in Person because, even though Nortel® is already doing well using that marketing vehicle, that marketing vehicle may be even more important than Nortel® realized.

The systems and methods described above allow a consumer services company concerned with brand penetration and market position to determine what marketing vehicles to use for various aspects of the purchasing cycle. As a result, such a company may advantageously re-direct resources from less effective marketing vehicles to more effective marketing vehicles. Furthermore, this re-allocation of resources may be done in a quantitative way, because a user may quickly determine how to reallocate resources to be most effective. Although embodiments of the present invention have been described, various modifications and changes may be made by those skilled in the art without departing from the spirit and scope of the invention.

What is claimed is:

1. A method of analyzing marketing activities comprising the steps of:
conducting a plurality of marketing surveys, the marketing surveys comprising a plurality of open-ended questions, the marketing surveys designed to elicit responses that may be categorized by marketing stage and brand awareness, the marketing surveys being directed at respondents with selected business segment, entity size, and job responsibility characteristics, the marketing surveys further directed at a predetermined number of sales and marketing vehicles;
calculating an overall average percentage impact awareness score for all of the predetermined marketing vehicles and for each of awareness, consideration and purchase issues of the purchase process cycle by:
taking the total number of marketing vehicles listed in the marketing surveys;
for each of the issues awareness, consideration, and purchase, requiring marketing survey respondents to specify a predetermined number of the marketing vehicles that have the most effect on the respondent, which predetermined number is fewer than all of the total number; and
forming the overall average percentage impact awareness score by dividing the specified predetermined number of marketing vehicles by the total number of marketing surveys listed in the marketing surveys;
deriving an individual percentage impact awareness score for each individual predetermined marketing vehicle from responses given in the marketing surveys;
plotting the individual percentage impact awareness score on a graph having each marketing vehicle listed along a first axis and each individual predetermined marketing vehicle score along a second axis, the second axis further including an indicator of the calculated overall average percentage impact awareness score for all of the predetermined marketing vehicles;
calculating an overall average brand propensity index by calculating what percent of respondents mentioned an individual brand in response to a question of the marketing surveys, adding all of the non-zero percentages, and dividing the sum by the number of brands mentioned;
deriving a brand propensity index for a single brand for each individual marketing vehicle from the responses given in the marketing surveys by:
having each marketing survey respondent identify as many brands as they recall seeing for each marketing vehicle and as many brands as they would be open to considering for each marketing vehicle; and
for each of the brands mentioned, dividing the number of respondents who mention a brand by the total number of respondents of the marketing surveys;
plotting the brand propensity index for the single brand on the graph along a third axis opposite to but co-linear with the second axis, the third axis further including an indicator of the calculated overall brand propensity index; and
comparing the brand propensity index for the single brand to the indicator of the calculated overall brand propensity index, the percentage impact awareness score for each individual predetermined marketing vehicle, and the overall average percentage impact awareness score for all of the predetermined marketing vehicles.

2. A method of analyzing marketing activities comprising the steps of:
obtaining data from a plurality of marketing surveys;
calculating an average percentage impact awareness score based on the data obtained from the marketing surveys;
deriving an individual percentage impact awareness score for each individual predetermined marketing vehicle from responses given in the marketing surveys;
plotting the individual percentage impact score on a graph having a plurality of marketing vehicles along a first axis and an individual predetermined marketing vehicle score along a second axis;
calculating an average brand propensity index based on data obtained from the marketing survey;
deriving a brand propensity index for a single brand for each individual marketing vehicle from the data in the marketing surveys; and
plotting the brand propensity index for the single brand along a third axis of the graph.

3. The method of claim 2 further comprising the step of comparing the brand propensity index for the single brand to the indicator of the calculated overall brand propensity index.

4. The method of claim 2 further comprising the step of comparing the brand propensity index for the single brand to the individual percentage impact awareness score.

5. The method of claim 2 further comprising the step of comparing the brand propensity index for the single brand to the overall average percentage impact awareness score.

6. The method of claim 2 wherein the marketing surveys are designed to elicit responses that may be categorized by marketing stage and brand awareness.

7. The method of claim 2 wherein the marketing surveys are directed at respondents from at least one of a predetermined business segment, entity size, or job responsibility characteristics.

8. The method of claim 2 wherein the marketing surveys are directed at a predetermined number of sales and marketing vehicles.

9. The method of claim 2 wherein the marketing surveys comprise a plurality of open-ended questions.

10. The method of claim 2 wherein the percentage impact awareness score is calculated for at least one marketing vehicle.

11. The method of claim 2 wherein the percentage impact awareness score is calculated for at least one of the awareness, consideration and purchase issues of the purchase process cycle.

12. The method of claim 2 wherein the percentage impact awareness score is calculated by the steps of:
taking a total number of marketing vehicles given in the marketing survey data;
for at least one of awareness, consideration, and purchase, taking data given in the marketing survey data about a predetermined number of marketing vehicles, which predetermined number of marketing vehicles is fewer than the total number; and
forming the average percentage impact awareness score by dividing the predetermined number of marketing vehicles by the total number of marketing surveys.

13. The method of claim 2 wherein the brand propensity index is derived by the steps of dividing the number of brands the marketing survey data indicates respondents would be open to considering for a marketing vehicle by the the total number of brands identified in the marketing survey data.

14. The method of claim 2 wherein the second axis includes an indicator of the average percentage impact awareness score.

15. The method of claim 2 wherein the average brand propensity index is calculated by taking a sum of a first predetermined number of brands identified in the marketing survey data and dividing that sum by a second predetermined number of brands identified in the marketing survey data.

16. The method of claim 2 wherein the third is axis opposite to but co-linear with the second axis.

17. The method of claim 2 wherein the third axis further includes an indicator of the calculated overall brand propensity index.

18. A method comprising the steps of:
calculating an average percentage impact awareness score based on marketing survey data;
deriving an individual percentage impact awareness score for a marketing vehicle listed in the marketing survey data;
calculating an average brand propensity index based on the marketing survey data;
deriving a brand propensity index for a single brand for each marketing vehicle listed in the marketing survey data;
plotting the individual percentage impact score on a graph showing marketing vehicles along a first axis and individual predetermined marketing vehicle scores along a second axis; and
plotting the brand propensity index for the single brand along a third axis of the graph.
